(19) United States
(12) Patent Application Publication
(10) Pub. No.: US 2026/0346750 A1
(43) Pub. Date: Nov. 5, 2026

(54) BI-DIRECTIONAL VEHICLE-TO-EVERYTHING POWER-SHARING ARCHITECTURE

(71) Applicant: Atieva, Inc., Newark, CA (US)

(72) Inventors: Seyed Amir Assadi, Fremont, CA (US); Shantanu Gupta, Fremont, CA (US); Dung Anh Nguyen, Hayward, CA (US); Yucheng Gao, Newark, CA (US); Shanjiao Jiang, Hayward, CA (US); Shan Chai, Fremont, CA (US)

(21) Appl. No.: 19/197,392

(22) Filed: May 2, 2025

(51) Int. Cl. B60L 53/62; B60L 53/18; B60L 53/66; H02J 1/08; H02J 1/10

(52) U.S. Cl. CPC B60L 53/62; B60L 53/18; B60L 53/665; H02J 1/084; H02J 1/106; B60L 2210/30; B60L 2240/547

(57) ABSTRACT

A charging station system comprises: a DC bus; a grid connection configured to provide DC power from a grid; charging cables having charging connectors to be connected to respective EVs, the charging station system not including DC-to-DC converters between the DC bus and the charging connectors, each of the EVs configured for charging by at least a first connection where an EV battery is directly connected to the DC bus without using an onboard charger of the EV and a second connection where the battery is connected using the onboard charger; a communication bus that facilitates communication between the charging station system and each of the EVs; and a charging station controller configured to, based on the communication, i) cause each of the EVs to be connected to the DC bus using one of the first connection or the second connection and ii) regulate a voltage of the DC bus.

### TECHNICAL FIELD

This document relates to a power-sharing architecture that enables vehicle-to-everything (V2X) charging and discharging.

### BACKGROUND

Alternating current (AC) transmission has historically been used to transmit power between generators and loads over long distances. With the proliferation of direct current (DC) sources like solar panels, stationary battery energy storage, and DC loads such as high voltage batteries of electric vehicles (EVs), power transfer through a direct DC connection can be used in smaller micro-grid installations. Some existing charging stations that make multiple ports available for charging EVs have used an alternating current (AC) bus, typically with an EV supply-equipment (EVSE) interface that may include relays and a ground fault interrupter. In literature, DC micro-grid designs have incorporated stationary storage either through a power-electronic converter or directly.

### SUMMARY

In a first aspect, a charging station system comprises: a direct current (DC) bus; a grid connection configured to provide DC power from a grid to the DC bus; charging cables having charging connectors configured to be connected to respective electric vehicles (EVs), wherein the charging station system does not include DC-to-DC converters connected between the DC bus and the charging connectors, and wherein each of the EVs is configured for charging by at least a first connection where a battery of the EV is directly connected to the DC bus without using an onboard charger of the EV and a second connection where the battery is connected to the DC bus using the onboard charger; a communication bus that facilitates communication between the charging station system and each of the EVs; and a charging station controller configured to, based on the communication, i) cause each of the EVs to be connected to the DC bus using one of the first connection or the second connection and ii) regulate a voltage of the DC bus.

Implementations can include any or all of the following features. At least one EV of the EVs has a modular onboard charger. At least one EV of the EVs does not have a modular onboard charger. Also a stationary storage is connected to the DC bus using the first connection. The charging station controller is configured to charge the stationary storage. The grid provides alternating current (AC) power. The grid connection includes an AC-to-DC converter.

In a second aspect, a method of operating a charging station system comprises: performing a determination, based on communications between the charging station system and electric vehicles (EVs) through a communication bus, that a first EV of the EVs is to be provided prioritized charging by the charging station system, and that at least a second EV of the EVs is to provide energy from its battery for the prioritized charging, wherein the charging station system includes a direct current (DC) bus and a grid connection configured to provide DC power from a grid to the DC bus, and wherein the grid has a fee-based power threshold; connecting, based on the determination, the first EV to the DC bus using a first connection where a battery of the first EV is directly connected to the DC bus without using an onboard charger of the first EV; connecting, based on the determination, the second EV to the DC bus using a second connection where a battery of the second EV is connected to the DC bus using an onboard charger of the second EV; and providing, as the prioritized charging, first power to the first EV, while ensuring that the fee-based power threshold of the grid is not exceeded.

Implementations can include any or all of the following features. Performing the prioritized charging further comprises receiving second power from the second EV, wherein the first power provided to the first EV includes the second power and third power obtained from the grid. Performing the prioritized charging further comprises providing second power to the second EV, wherein third power obtained from the grid includes the first power and the second power. The method further comprises connecting also a stationary storage to the DC bus using the first connection.

In a third aspect, a method of operating a charging station system having a direct current (DC) bus comprises: receiving, by the charging station system, communications from a first electric vehicle (EV) and a second EV through a communication bus; connecting the first EV to the DC bus of the charging station system, based on the communications and an efficiency of at least an onboard charger of the second EV, the first EV connected using a first connection where a battery is directly connected to the DC bus without using an onboard charger of the first EV; connecting the second EV to the DC bus using a second connection where the battery is connected to the DC bus using the onboard charger of the second EV; performing a determination, while the first EV is being charged using the first connection and the second EV is being charged using the second connection, that the efficiency of the onboard charger no longer meets an efficiency criterion; and in response to the determination, instead connecting the first EV to the DC bus using the second connection where the battery of the first EV is connected to the DC bus using the onboard charger of the first EV, and instead connecting the second EV to the DC bus using the first connection where the battery of the second EV is directly connected to the DC bus without using the onboard charger of the second EV.

Implementations can include any or all of the following features. The communications include information reflecting states of batteries of the first EV and the second EV, respectively. The information includes at least one of battery voltage and state of charge. The efficiency criterion comprises that the charging station system is operating at maximum efficiency. Performing the determination that the efficiency of at least the onboard charger no longer meets the efficiency criterion comprises using an efficiency diagram. Also a stationary storage is connected to the DC bus using the first connection. The method further comprises changing a voltage of the DC bus in response to the determination. The method further comprises supplying power from a grid to the DC bus. The grid has a fee-based power threshold, the method further comprising ensuring that the fee-based power threshold of the grid is not exceeded. Performing the determination that the efficiency of at least the onboard charger no longer meets the efficiency criterion comprises taking into account an efficiency of a grid-connected converter of the charging station system.

### BRIEF DESCRIPTION OF DRAWINGS

FIG. 1 shows an example of a charging station system.

FIG. 2 shows an example of an onboard charger (OBC) that can be used with a charging station system described herein.

FIG. 3 shows another example of the OBC of FIG. 2.

FIG. 4 shows another example of the charging station system of FIG. 1.

FIG. 5 shows another example of the charging station system of FIG. 1.

FIG. 6 shows another example of the charging station system of FIG. 1.

FIG. 7 shows another example of the charging station system of FIG. 1.

FIG. 8 shows an example of an efficiency diagram for a DC-to-DC converter that can be used with a charging station system described herein.

FIG. 9 shows another example of the charging station system of FIG. 1.

FIG. 10 shows another example of an efficiency diagram that can be used with a charging station system described herein.

Like reference symbols in the various drawings indicate like elements.

### DETAILED DESCRIPTION

This document describes examples of systems and techniques for multiport charging stations having improved power-sharing architectures. This can provide low-cost, efficient and high-power transfer of energy between equipment such as EVs or stationary storage and the grid in multiport charging stations. In some implementations, a charging station system is configured to charge (e.g., fast charge) or obtain power from EVs that can connect via direct DC connection as well as through the EV's onboard charger (OBC), and let a directly connected battery (e.g., in an EV) drive the voltage of a DC bus of the charging station system. This can deliver power to one or more charged systems (e.g., EVs or a stationary storage) in form of a differential power that lets the charging station system operate more efficiently and/or at lower cost. In some implementations, the present subject matter can eliminate the use of DC-to-DC converters at the front end of the charging station system by instead relying on the EV's ability to both directly connect to DC and the AC from the same charge port of the EV. That is, such DC-to-DC converters have been used on both sides of the DC bus to provide flexibility in that the charging system can set any voltage in the middle as long as it satisfies the equipment on each side.

In the present subject matter a direct connection of a battery to the charging station system can allow fast charging of that battery, and the charging station system can offer enhanced charging powers by passing power between two or more batteries (e.g., in an EV or a stationary storage). With a direct connection to the DC bus, the state of the directly connected battery (e.g., its voltage, or state of charge) can control the voltage of the DC bus without using the OBC of the directly connected EV.

In some implementations, the present subject matter provides an improved charging station system that includes at least: a DC bus serving as a common power rail with multiple charging cables and at least one communication line for the connected EVs or stationary storage; the ability to connect to EVs that can connect to the DC bus either directly or through an OBC (e.g., the OBC can be a reconfigurable, modular isolated bi-directional OBC that is capable of DC-to-DC conversion operation); and a connection that supports the choice between direct connection and connection via the OBC. This connection which enables either a direct connection to the battery or a connection through the OBC can be established either by the EVSE or the EV.

In some implementations, a multi-module bi-directional isolated OBC can provide the advantage of HV DC bus compatibility. For example, an EV can be charged or discharged through a DC bus having a peak voltage higher than the rated voltage of a single OBC module.

In some implementations, a charging station system can provide low-cost prioritized fast charging. This can provide the ability to fast charge one prioritized EV through a direct connection of its HV battery to the DC bus, while one or more other connected EVs provide (at least part of) the charging power for the prioritized EV through their respective OBC that are capable of DC-to-DC conversion. The discharge power from the donor EV, or each of multiple donor EVs, is limited by the OBC power rating of the respective donor EV. However, the charge rating for the prioritized EV is limited only by its HV battery capability since its OBC is not presently being used. This and similar approaches can unlock the potential to achieve sporadic on-demand high-power charging in low-cost multiport stations by leveraging the storage energy of one or more other available vehicles.

In some implementations, a charging station system can provide decentralized dynamic optimization of the DC bus voltage by always selecting the right EV among the EVs connected to the charging station system. This can be based on the ability to coordinate each EV's charge/discharge power in a decentralized manner. Moreover, the DC bus voltage can be changed to optimize the overall power transfer efficiency.

As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. An EV can be powered exclusively by electricity, or can use one or more other energy sources in addition to electricity, to name just a few examples. As used herein, an EV includes an onboard energy storage, sometimes referred to as a battery or battery pack, to power one or more electric motors. Two or more EVs can have different types of energy storages and/or different sizes thereof.

As used herein, a battery is an assembly of one or more electrochemical cells for storing electrical energy. A battery can be installed in a vehicle (e.g., by way of a battery pack or otherwise) or in a stationary installation (sometimes referred to as stationary storage).

As used herein, vehicle-to-vehicle (V2V) charging means charging that is performed with at least two EVs, wherein a first EV serves as a donor EV for energy and one or more second EVs serve as acceptor EVs for energy. The V2V charging involves discharging the donor EV and charging the second EV(s). Charging an energy storage involves supplying energy into the storage and increasing its state of charge (SOC). Discharging an energy storage involves removing energy from the storage and decreasing its SOC. As such, in V2V charging there is both charging and discharging involved, of separate EVs. Moreover, an electrical connector that is coupled to an EV is sometimes referred to as a charging gun. In V2V charging, respective charging guns are coupled to each of the EVs. That is, charging guns are used for both the donor EV and the acceptor EV(s). When an EV is instead being charged with electricity from a grid, this can be referred to as grid-to-vehicle (G2V) charging.

As used herein, a power grid, or a grid for short, means a grid that supplies power includes any of multiple types of networks for delivering electricity from a producer to one or more consumers. A grid can be owned and/or operated by any of multiple types of actors, including, but not limited to, a public entity (e.g., a municipality, city, state, or country) that may act through one or more utility companies, or a private entity (e.g., a corporation, another private enterprise, or an individual). A grid can deliver electricity to a building at any of multiple levels of power.

As used herein, being connected means to be electrically connected, unless otherwise stated.

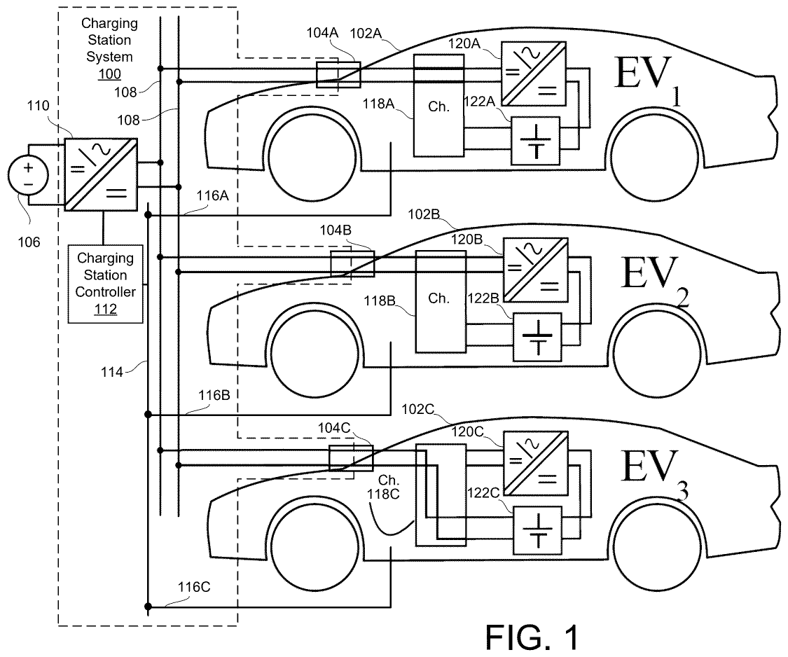

FIG. 1 shows an example of a charging station system 100. The charging station system 100 can be used with one or more other examples described elsewhere herein. The charging station system 100 is schematically illustrated for clarity and is here shown to be connected to EVs 102A, 102B and 102C, which are also schematically illustrated and represent any kind of EV of the same or different types as each other. More or fewer EVs than three can be used with the charging station system 100. The EV 102A is connected to the charging station system 100 by a charging connector 104A, the EV 102B by a charging connector 104B, and the EV 102C by a charging connector 104C, respectively. The charging gun head is plugged into the EV itself. The end of the cable that does not have the plug connects to the EVSE hardware. The charging connectors 104A-104C are schematically illustrated and represent any kind of charging connector compatible with the respective EV 102A-102C and with the charging station system 100. The charging connectors 104A-104C can be mounted at the end of charging cables for being connected to respective charge ports of the EVs 102A-102C.

The charging station system 100 can be supplied with power from at least a grid 106. In some implementations, the grid 106 provides AC power to the charging station system 100. The charging station system 100 can include a grid connection that is configured to provide DC power from the grid 106 to a DC bus 108. The DC bus 108 is here illustrated as including two rails for supplying DC power to one or more of the EVs 102A-102C. In some implementations, the grid connection can include an AC-to-DC converter 110. The AC-to-DC converter 110 can be implemented using one or more stages. In other implementations, the charging station system 100 can operate without the grid 106, for example by allowing power transfer between some or all of the EVs 102A-102C and/or a stationary storage.

The charging station system 100 includes a charging station controller 112 that operates the charging station system 100 and causes it to perform one or more functions. The charging station controller 112 can be implemented using circuitry. For example, the charging station controller 112 can include one or more chips or other integrated circuits that perform operations based on instructions stored in a computer-readable medium. The charging station controller 112 can control the operation of the grid connection (e.g., the AC-to-DC converter 110) and can regulate the voltage of the DC bus 108.

The charging station system 100 can include a communication bus 114 that facilitates communication between the charging station system 100 and each of the electric vehicles 102A-102C. The communication bus 114 is controlled by the charging station controller 112 which decides what information to convey to any or all of the EVs 102A-102C, and which receives the information provided through the communication bus 114 by any of the EVs 102A-102C. The EV 102A is connected to the communication bus 114 by a communication branch 116A, the EV 102B by a communication branch 116B, and the EV 102C by a communication branch 116C, respectively. The communication bus 114 can use wired and/or wireless connections. Each of the communication branches 116A-116C can include a wired or wireless connection. As such, in the drawing, each of the lines of the communication branches 116A-116C represents a wired or wireless connection. In some implementations, the communications between the charging station system 100 and the EVs 102A-102C can include a handshake procedure (e.g., according to the specifications of the charging protocol that the charging station system 100 is configured to apply). To begin the communications when any of the EVs 102A-102C arrives, the charging station system 100 can announce its capability or capabilities with regard to charging (e.g., its power capacity, energy prices, and/or the availability of prioritized charging). One or more of the EVs 102A-102C can announce a state of its battery (e.g., an SOC and/or voltage) to the charging station system 100 for purposes of initiating a charging session. For example, if the charging station system 100 advertises in the communications that it is capable of charging up to a given level, the EV can specify in its communication a requested power level consistent with the announced power capacity. When two or more of the EVs 102A-102C are part of a fleet of EVs that are controlled by the same entity (e.g., a fleet that is operated by a transportation company) the charging needs for those EVs can be internally coordinated and concerted requests can be made using the communication bus 114 (e.g., to present a united front towards the charging station system 100). As another example, when some or all of the EVs 102A-102C are not part of a fleet but rather are controlled by members of the public that have chosen to visit the charging station system 100, the charging station controller 112 can engage in communications individually with the EVs (e.g., to obtain information about their charging needs and whether they may be available for participating in priority charging sessions as either a recipient or a donor of energy).

Here, the EV 102A has a charge port (Ch.″) connection 118A, the EV 102B has a charge port connection 118B, and the EV 102C has a charge port connection 118C, respectively. Also, the EV 102A has an OBC 120A, the EV 102B has an OBC 120B, and the EV 102C has an OBC 120C, respectively. Finally, the EV 102A has a battery 122A, the EV 102B has a battery 122B, and the EV 102C has a battery 122C, respectively.

The charge port connections 118A-118C allow each of the EVs 102A-102C, respectively, to engage in energy transfer with (i.e., to be charged or discharged by) the charging station system 100 by either a first connection or a second connection. In some implementations, the first connection involves the respective battery 122A, 122B or 122C being directly connected to the DC bus 108 without using the OBC 120A, 120B or 120C, respectively. In some implementations, the second connection involves the respective battery 122A, 122B or 122C being connected to the DC bus 108 using the OBC 120A, 120B or 120C, respectively.

That is, unlike some existing charging stations, the charging station system 100 does not include DC-to-DC converters connected between the DC bus 108 and the charging connectors 104A-104C. The present subject matter can provide a charging architecture that dynamically connects EVs at a multiport station to a DC bus through either the first connection (e.g., a DC fast-charge path) or the second connection (e.g., an OBC path such as an AC path). In doing so, the present subject matter can allow the charging station system 100 to treat one or more of the batteries 122A-122C connected to the DC bus 108 as if it were a stationary storage system. For example, the charging station system 100 can operate according to principles in which any of the batteries 122A-122C emulates a stationary storage. This and similar approaches can enable low-cost, prioritized fast charging, vehicle-to-vehicle load sharing, and optimal power transfer efficiency.

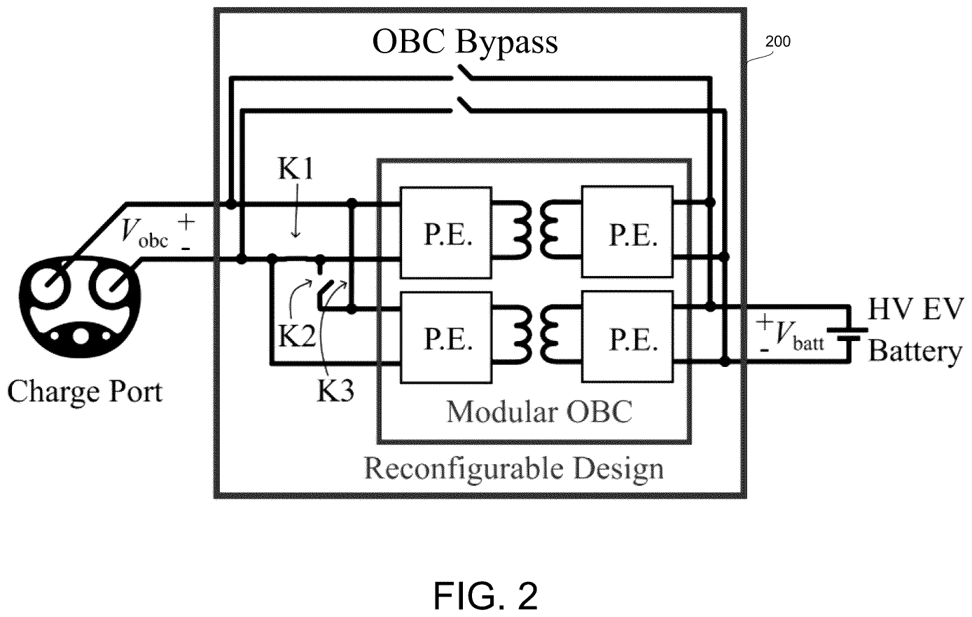

FIG. 2 shows an example of an OBC 200 that can be used with a charging station system described herein. In some implementations, one or more of the OBCs 120A, 120B or 120C of FIG. 1 can include an instance of the OBC 200. The OBC 200 illustrates an example of a two-module bi-directional isolated OBC. The OBC 200 has a reconfigurable design (e.g., that is able to be placed either in series or parallel) as will be exemplified in the following description.

The OBC 200 is configured for being connected to a charge port of the vehicle. Here, that charge port conforms to the SAE J3400 standard, but any other charge port that supports charging selectively using either the first connection or the second connection mentioned above can be used instead. The voltage of the charge port is here referred to as V_{obc} with positive (+) and negative (−) symbols for the respective terminals. The OBC 200 is connected to an HV EV battery of the vehicle, which is here schematically represented using one battery symbol having respective positive and negative terminals.

The OBC 200 includes a modular OBC that includes isolated input power electronics (P.E.) stages and one or more transformers having respective power electronics. Here, the modular OBC includes two transformers, each having respective power electronics at its primary side and at its secondary side. The OBC 200 includes reconfiguration switches, labeled K1, K2 and K3, between the terminals of the charge port and the modular OBC. Using the reconfiguration switches, this two-module design can be operated as an isolated DC-to-DC converter with an output voltage that is at least rated for two times the input voltage of the OBC, or V_{obc}. The modular design lets the EV track the highest voltages without the OBC 200 being overdesigned. Other implementations with a higher number of modules can interface with an even higher voltage DC bus. For example, this enables the direct connection of EVs with 1000 V architectures to the DC bus. The OBC 200 uses a bypass circuit, here labeled OBC bypass, that allows the OBC 200 to bypass the modular OBC and instead directly connect the charge port and the HV EV battery to each other. This bypass (which can be, but is not necessarily, co-packaged with the OBC) enables direct connection of the HV EV battery to a DC bus.

In the present illustration the OBC bypass is open (i.e., there is no bypass) and the configuration of the switches K1, K2 and K3 corresponds to the two modules of the modular OBC interfacing with the DC bus in parallel. That is, the charge port sides of the respective modules are here connected in parallel with each other. In the illustrated configuration, K1 and K3 are closed, and K2 is open.

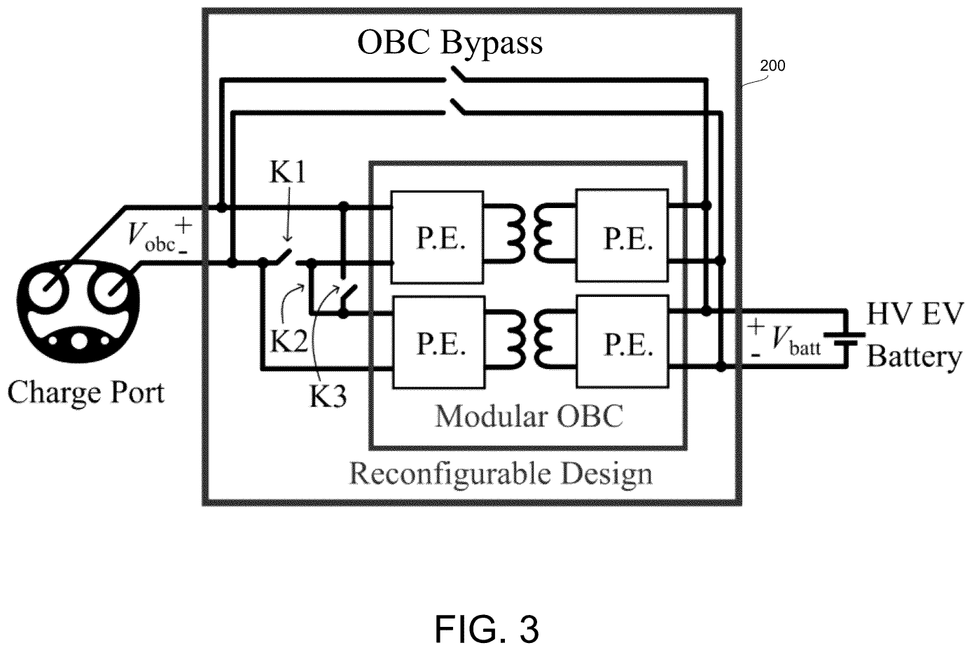

FIG. 3 shows another example of the OBC 200 of FIG. 2. In the present illustration the OBC bypass is open (i.e., there is no bypass) and the configuration of the switches K1, K2 and K3 corresponds to the two modules of the modular OBC interfacing with the DC bus in series to achieve a higher voltage rating. That is, the charge port sides of the respective modules are here connected in series with each other. In the illustrated configuration, K1 and K3 are open, and K2 is closed.

The modularity of the modular OBC of the OBC 200 can be done in various ways, such as by power level. In some implementations, the modularity can be implemented using one module per phase of the current. In other implementations, the OBC 200 is not modular. If one knows that the voltage ranges of the EVs that will connect to the charging station system are within an acceptable range of the DC bus, modularity need not be provided. It may be sufficient that the voltage ranges are similar to and therefore compatible with what a standard grid connection of the charging station system would be. For example, modularity may not be necessary in the OBCs of an EV fleet if the EVs of the fleet are expected to have a maximum OBC voltage that is more than the voltage of the EV fleet batteries, and subsequently the DC bus.

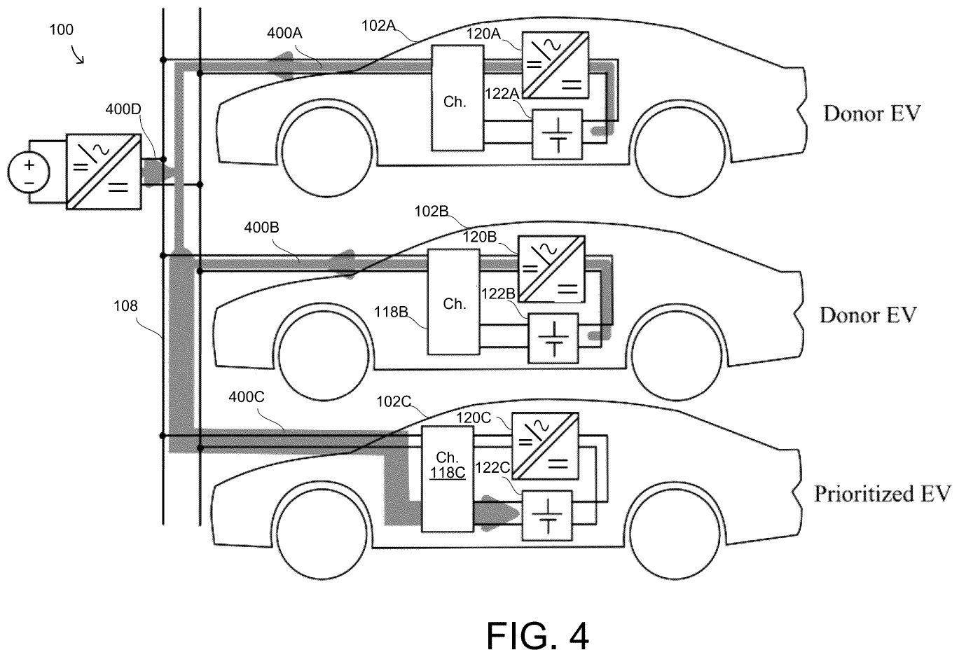

FIG. 4 shows another example of the charging station system 100 of FIG. 1. For clarity, not all components of the charging station system 100 are shown. The charging station system 100 can advantageously provide priority high-power charging to a connected piece of equipment (e.g., an EV or a stationary storage) by relying on one or more other connected pieces of equipment to act as donors in addition to the power obtained from the grid. The charging station system 100 can do so without necessarily drawing a significant amount of power from the grid during the priority charging. The pricing that a power company charges the operator of a charging station typically varies based on at least the amount of power used. In some areas, the power company can apply a fee-based power threshold on the pricing for the power that the grid delivers to the charging station. Such fee-based power threshold can be applied if the power station reaches a specified power threshold at least once during a certain period. For example, if the power station reaches the power threshold on at least one occasion during a billing period the cost of the grid power can increase significantly compared to if the power threshold had not been reached. Providing high-power fast charging, even sporadically, can increase the likelihood of incurring the additional cost associated with the fee-based power threshold.

In this example, the charging station system 100 will provide prioritized high-power charging for the EV 102C. For example, the charging station system 100 may have offered prioritized charging to at least the EV 102C as part of its communication, and here the EV 102C requested that the prioritized charging be performed. One or more other energy sources connected to the charging station system 100 can act as donors to supply at least part of the energy for the prioritized charging. In some implementations, the charging station system 100 in its communications can offer the opportunity to serve as an energy donor (e.g., in return for some benefit). In other implementations, the equipment connected to the charging station system 100 can be controlled by a single entity (e.g., by the organization that operates a fleet of EVs) and that entity specifies whether any of the equipment (e.g., one or more EVs) will serve as donors.

Here, the EV 102C is provided electric power 400C as part of the prioritized charging. In this illustration, the flow of energy is schematically illustrated with arrows that indicate the source and destination of the power, and whose widths reflect the amount of power being transferred. The EV 102C has its battery 122C directly connected to the DC bus 108 based on the charge port connection 118C and is not currently using the OBC 120C. The charging power of the EV 102C is therefore only limited by the capability of the battery 122C which is typically much higher than the rating of the OBC 120C. The battery 122C will drive the voltage of the DC bus 108 while the battery 122C is directly connected to the DC bus 108.

The EV 102A here uses its OBC 120A to connect its battery 122A to the DC bus 108. The EV 102A is a donor for the prioritized charging and delivers electric power 400A to the DC bus 108 from the battery 122A. Similarly, the EV 102B here uses its OBC 120B to connect its battery 122B to the DC bus 108, and as a donor for the prioritized charging delivers electric power 400B to the DC bus 108 from the battery 122B. The charging station system 100 here obtains electric power 400D from the grid which is sufficiently low that the fee-based power threshold of the grid is not exceeded. By using the EVs 102A-102B as local energy storage for the prioritized charging, and drawing at most a threshold amount from the grid, the charging station system 100 can rapidly charge the EV 102C upon demand (i.e., a sporadic high charge rate) while using a weak, low-cost grid connection. That is, the EV 102C can be charged with a higher power level than the grid value and the OBC rating of the EV 102C. Also, the EV 102C is charged with a higher efficiency by having the battery 122C directly connected to the DC bus 108 because the charge port connection 118C here bypasses the power electronics of the OBC 120C.

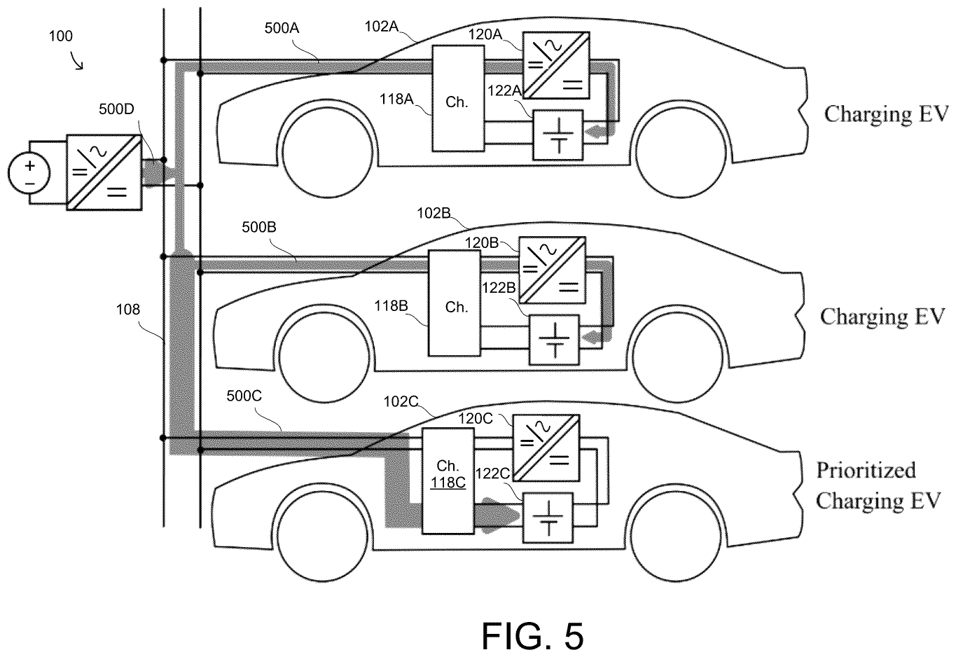

FIG. 5 shows another example of the charging station system 100 of FIG. 1. When no equipment (e.g., EVs or stationary storage) is available to serve as a donor when prioritized charging is requested (e.g., by an EV), the charging station system 100 can still provide the prioritized charging using a direct connection to the DC bus 108. Here, the EV 102C has its battery 122C directly connected to the DC bus 108 without using the OBC 120C and is charged with electric power 500C. The EV 102A has its battery 122A connected to the DC bus 108 through the OBC 120A due to the charge port connection 118A, and is charged with electric power 500A, which is substantially lower than the electric power 500C. Similarly, the EV 102B has its battery 122B connected to the DC bus 108 through the OBC 120B due to the charge port connection 118B, and is charged with electric power 500B, which is substantially lower than the electric power 500C. Here, electric power 500D is drawn from the grid to provide the electric powers 500A, 500B and 500C. That is, the station architecture can ensure that only the EV demanding the highest charge power (here, the EV 102C) receives the high-power connection. In some implementations, the charging station system 100 can regulate the electric powers 500A, 500B and 500C so that the electric power 500D does not exceed a fee-based power threshold.

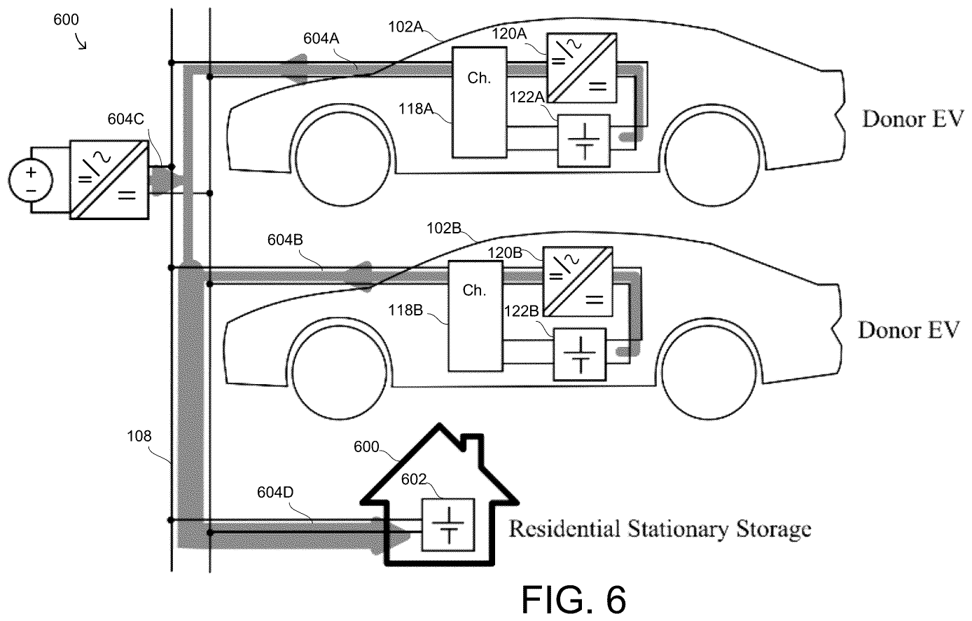

FIG. 6 shows another example of the charging station system 100 of FIG. 1. In V2H applications, EVs can serve as local energy storage elements that can charge a local stationary storage (e.g., for a residence). Here, a building 600 (e.g., a residence) has a stationary storage 602 that is directly connected to the DC bus. The charging power of the stationary storage 602 is therefore only limited by the capability of the stationary storage 602. The stationary storage 602 will drive the voltage of the DC bus 108 while the stationary storage 602 is directly connected to the DC bus 108.

The EV 102A here uses its OBC 120A to connect its battery 122A to the DC bus 108. The EV 102A is a donor for the charging of the stationary storage 602 and delivers electric power 604A to the DC bus 108 from the battery 122A. Similarly, the EV 102B here uses its OBC 120B to connect its battery 122B to the DC bus 108, and as a donor for the charging of the stationary storage 602 delivers electric power 604B to the DC bus 108 from the battery 122B. The charging station system 100 here obtains electric power 604C from the grid so that, together with the electric powers 604A and 604B, electric power 604D is provided to the stationary storage 602. Accordingly, the charging station system 100 can use the batteries of one or more EVs to buffer a peak power draw of the stationary storage 602. As mentioned earlier, compared to conventional systems for charging either EVs or a stationary storage, the charging station system 100 can operate with great utility and advantage without using any extra conversion stages (e.g., DC-to-DC converters).

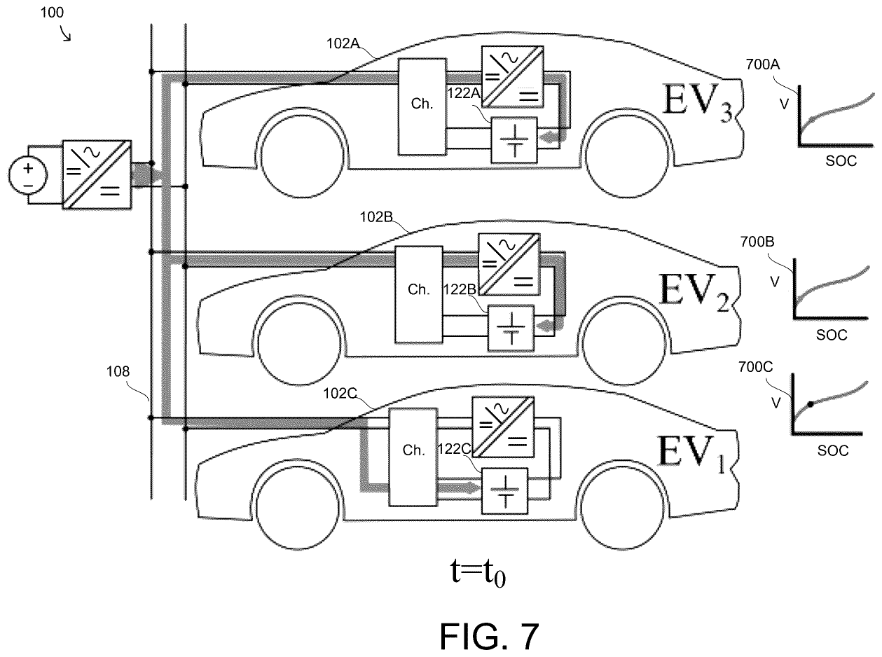

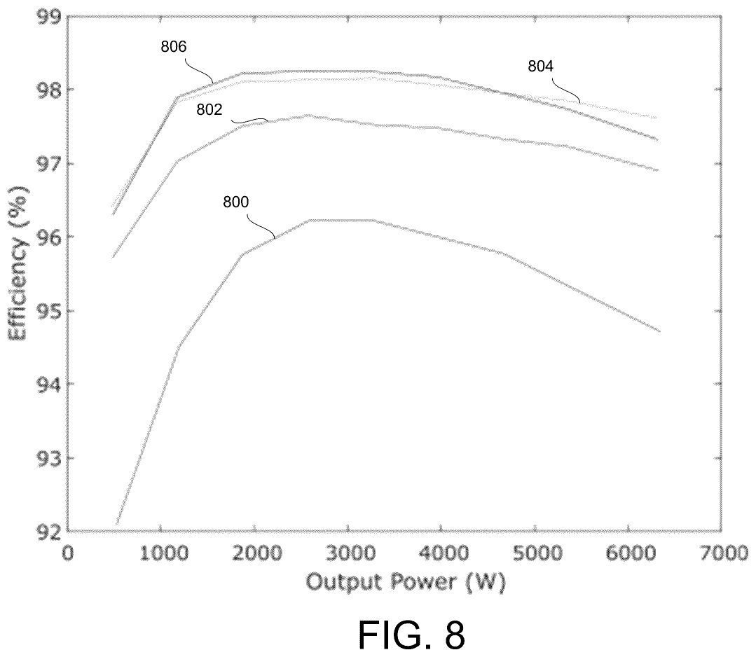

FIG. 7 shows another example of the charging station system 100 of FIG. 1. As will be described below, the charging station system 100 here will control the ways that equipment connects to the DC bus 108. In multi-port installations with multiple occupied ports, the DC-bus voltage can be adjusted for optimal efficiency in all vehicles, thereby reducing operational costs. Unlike an AC-bus, the DC-bus voltage can match the optimal operating point of the OBC power-electronics. FIG. 8 shows an example of an efficiency diagram for a DC-to-DC converter that can be used with a charging station system described herein. This efficiency curve shows a variation in converter efficiency due to different input voltages. Particularly, efficiency is shown on the vertical axis and output power on the horizontal axis. A curve 800 represents the variation in efficiency for an input voltage of 420 V, a curve 802 represents the variation in efficiency for an input voltage of 400 V, a curve 804 represents the variation in efficiency for an input voltage of 390 V, and a curve 806 represents the variation in efficiency for an input voltage of 380 V.

When multiple EVs connect to the DC bus, a common voltage must be agreed upon to achieve optimal efficiency in all EVs. If one EV connects directly, its battery SOC can change the DC-bus voltage as it gets charged, affecting other EVs'OBC power-electronics'efficiency. Past work has focused on optimizing power-flow to accommodate the voltage variation of the stationary storage battery in a DC-microgrid. The present subject matter can operate without a fixed stationary storage element and therefore has the challenge and opportunity of selecting which EV can be directly connected to the DC-bus, thus setting the common DC-bus voltage.

The charging station system 100 has access to voltage-SOC information about the EVs that are eligible to be connected to the DC bus 108. Here, the EV 102A is associated with information 700A, the EV 102B is associated with information 700B, and the EV 102C is associated with information 700C, respectively. In the information 700A-700C battery voltage is shown on the vertical axis and SOC of the battery on the horizontal axis to illustrate typical relationships between voltage and SOC as a battery is being charged. For example, each of the information 700A-700C can include at least one of battery voltage and state of charge. The EVs 102A-102C can convey the information 700A-700C, respectively, (e.g., in numerical form) to the charging station system 100 as part of their continuous or regular communications through the communication bus 114 of FIG. 1.

The EVs 102A-102C can begin their respective charging at the charging station system 100 at different times and may do so with initial SOCs that differ from each other. The charging station system 100 therefore can make decisions, from time to time, of what is the proper configuration of the various connections between the EVs 102A-102C and the DC bus 108 considering the overall efficiency of the charging processes that are being performed. This can take into account the efficiencies indicated by the curves 800-806, which indicate, for different input voltages and output powers, where the charging process has its maximum efficiency. The curves 800-806 represent a simplification in that the efficiency depends on both the input and output voltage of the DC-to-DC converter.

Here, the charging station system 100 (e.g., by operations performed by the charging station controller 112 of FIG. 1) can decide that the state of the battery 122C of the EV 102C is such that the efficiency of the charging station system 100 is the highest if the EV 102C is allowed to drive the voltage of the DC bus 108 for the time being. The charging station system 100 therefore connects the battery 122C directly to the DC bus 108 such that the voltage of the DC bus 108 will be regulated according to the state of the battery 122C. By contrast, the EVs 102A and 102B are being connected through their respective OBCs. The charging station system 100 can then re-evaluate this decision regularly or continuously. In this example, the efficiency of the OBC is being taken into account. Other approaches can be used. Some implementations can take into account the efficiencies of both the charging station and one or more EV OBCs. For example, if a fleet operator owns both the charging station and EVs that are being charged, the operator may want both the OBCs of the EVs and the grid-connected converter to operate efficiently, and the station can therefore control the respective connections accordingly.

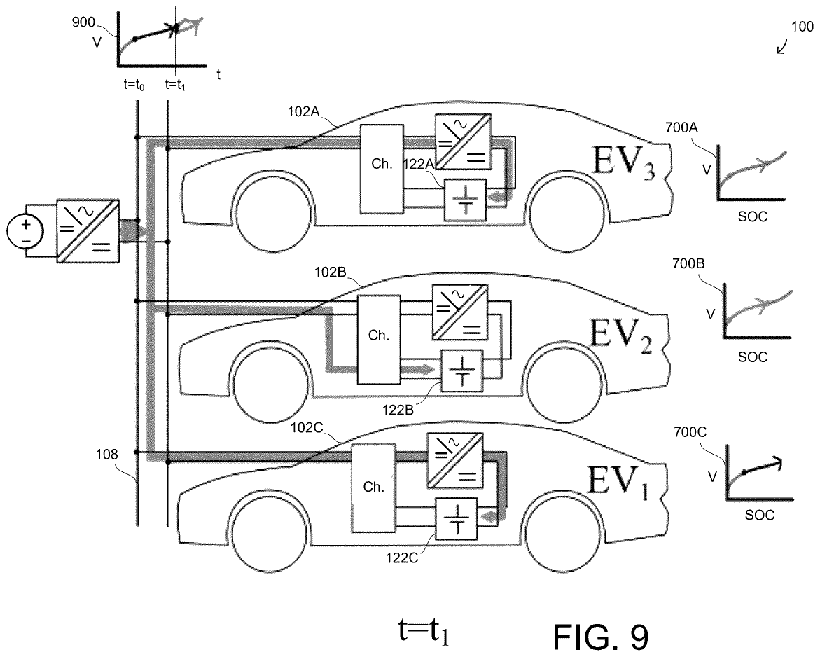

FIG. 9 shows another example of the charging station system 100 of FIG. 1. As mentioned above, the communication bus ensures that the correct EV HV battery is directly connected to the DC bus 108 to maintain optimal DC-bus voltage. The common communication bus allows for different EVs to be connected directly in time to always maintain the most optimal DC-bus voltage. At a later time during the charging than what is shown in FIG. 7, the charging station system 100 can decide that the EV 102B rather than the EV 102C should be directly connected to the DC bus 108. This decision can be based on the information 700A-700C, which can be continuously updated as the respective batteries are being charged and therefore change their state. Accordingly, the charging station system 100 therefore connects the battery 122B directly to the DC bus 108 such that the voltage of the DC bus 108 will be regulated according to the state of the battery 122B. By contrast, the EVs 102A and 102C are being connected through their respective OBCs. A diagram 900 indicates how the DC bus voltage (on the vertical axis) has progressed during the charging session (time on the horizontal axis). Initially, the voltage of the DC bus was driven by the battery 122C, and the diagram 900 indicates this development. After switching to instead directly connecting the battery 122B, the diagram 900 will continue to indicate the development of the DC bus voltage based on the state of the battery 122B from that point. As mentioned, the charging station system 100 can regularly or continuously re-evaluate the decision of which equipment is to be directly connected.

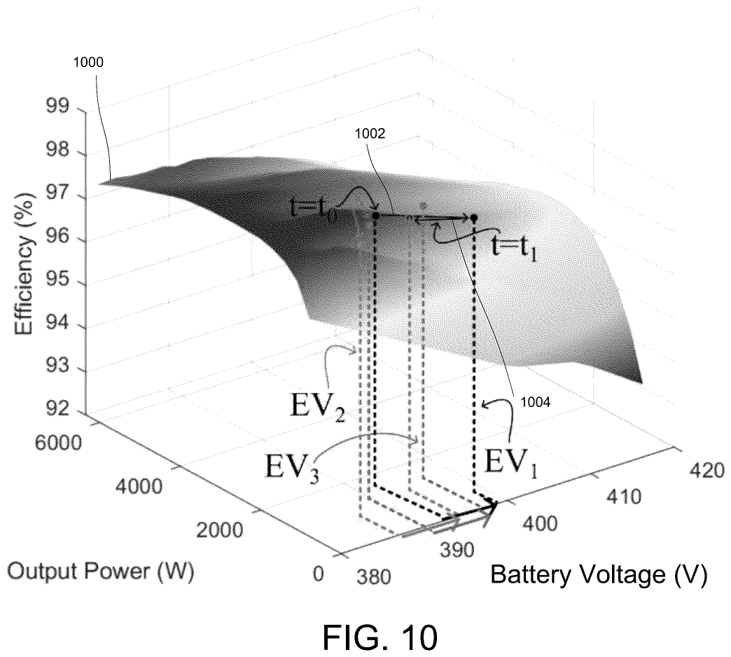

FIG. 10 shows another example of an efficiency diagram that can be used with a charging station system described herein. The diagram shows efficiency on a vertical axis with output power on a first horizontal axis and battery voltage on a second horizontal axis. A graph 1000 indicates the efficiency as a function of output power and battery voltage. The efficiency diagram shows that the highest efficiency (i.e., in the leftmost third of the graph 1000) is above 97%, and that the lowest efficiency (i.e., toward the lower right of the graph 1000) is about 93%.

The diagram reflects developments that occur in relation to a time t=t₀ (e.g., the situation depicted in FIG. 7) and a time t=t₁ (e.g., the situation depicted in FIG. 9). This example relates to three EVs named EV₁, EV₂ and EV₃ (e.g., corresponding to the EVs 102A, 102B and 102C, respectively). At t=t₀, the EV₁, EV₂ and EV₃ have some respective battery voltages and the charging system has a particular output voltage. Based on these conditions and the graph 1000, the charging station system can decide to directly connect the EV₁ to the DC bus. An arrow 1002 illustrates how the efficiency of the charging process develops according to the changing state of the battery of the EV₁. That is, at t=t₀ the OBCs of the EV₂ and EV₃ can operate at their highest efficiency when the DC bus voltage is equal to the voltage of the HV battery of the EV₁ through a direct connection.

Namely, eventually the charging process represented by the arrow 1002 leads to the system experiencing a less than optimal efficiency. For example, this can involve making a determination that an efficiency criterion is no longer being met by the charging process. Namely, the SOC and voltage of the HV battery of the EV₁ may have increased so that it no longer results in a DC bus voltage that ensures the highest efficiency charging of all EVs. At t=t₁, therefore, the charging station system can instead decide to directly connect the EV₂ to the DC bus, and the continued charging process from that point is illustrated by an arrow 1004. When the charging station system decides to connect the EV₂ directly the charging station system disconnects the EV₁ and continues charging the EV₁ using EV₁'s OBC until the EV₁ is done charging. As such, the charging station system can, from time to time, reevaluate the efficiency of the present connections to the DC bus and make changes that optimize the efficiency of the overall system based on the SOC of the HV battery, the OBC efficiency curve, and a maximum available charge power (e.g., from a grid and/or one or more pieces of donor equipment).

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A charging station system comprising:
a direct current (DC) bus;
a grid connection configured to provide DC power from a grid to the DC bus;
charging cables having charging connectors configured to be connected to respective electric vehicles (EVs), wherein the charging station system does not include DC-to-DC converters connected between the DC bus and the charging connectors, and wherein each of the EVs is configured for charging by at least a first connection where a battery of the EV is directly connected to the DC bus without using an onboard charger of the EV and a second connection where the battery is connected to the DC bus using the onboard charger;
a communication bus that facilitates communication between the charging station system and each of the EVs; and
a charging station controller configured to, based on the communication, i) cause each of the EVs to be connected to the DC bus using one of the first connection or the second connection and ii) regulate a voltage of the DC bus.

2. The charging station system of claim 1, wherein at least one EV of the EVs has a modular onboard charger.

3. The charging station system of claim 1, wherein at least one EV of the EVs does not have a modular onboard charger.

4. The charging station system of claim 1, wherein also a stationary storage is connected to the DC bus using the first connection.

5. The charging station system of claim 4, wherein the charging station controller is configured to charge the stationary storage.

6. The charging station system of claim 1, wherein the grid provides alternating current (AC) power.

7. The charging station system of claim 6, wherein the grid connection includes an AC-to-DC converter.

8. A method of operating a charging station system, the method comprising:
performing a determination, based on communications between the charging station system and electric vehicles (EVs) through a communication bus, that a first EV of the EVs is to be provided prioritized charging by the charging station system, and that at least a second EV of the EVs is to provide energy from its battery for the prioritized charging, wherein the charging station system includes a direct current (DC) bus and a grid connection configured to provide DC power from a grid to the DC bus, and wherein the grid has a fee-based power threshold;
connecting, based on the determination, the first EV to the DC bus using a first connection where a battery of the first EV is directly connected to the DC bus without using an onboard charger of the first EV;
connecting, based on the determination, the second EV to the DC bus using a second connection where a battery of the second EV is connected to the DC bus using an onboard charger of the second EV; and
providing, as the prioritized charging, first power to the first EV, while ensuring that the fee-based power threshold of the grid is not exceeded.

9. The method of claim 8, wherein performing the prioritized charging further comprises receiving second power from the second EV, wherein the first power provided to the first EV includes the second power and third power obtained from the grid.

10. The method of claim 8, wherein performing the prioritized charging further comprises providing second power to the second EV, wherein third power obtained from the grid includes the first power and the second power.

11. The method of claim 8, further comprising connecting also a stationary storage to the DC bus using the first connection.

12. A method of operating a charging station system having a direct current (DC) bus, the method comprising:
receiving, by the charging station system, communications from a first electric vehicle (EV) and a second EV through a communication bus;
connecting the first EV to the DC bus of the charging station system, based on the communications and an efficiency of at least an onboard charger of the second EV, the first EV connected using a first connection where a battery is directly connected to the DC bus without using an onboard charger of the first EV;
connecting the second EV to the DC bus using a second connection where the battery is connected to the DC bus using the onboard charger of the second EV;
performing a determination, while the first EV is being charged using the first connection and the second EV is being charged using the second connection, that the efficiency of the onboard charger no longer meets an efficiency criterion; and
in response to the determination, instead connecting the first EV to the DC bus using the second connection where the battery of the first EV is connected to the DC bus using the onboard charger of the first EV, and instead connecting the second EV to the DC bus using the first connection where the battery of the second EV is directly connected to the DC bus without using the onboard charger of the second EV.

13. The method of claim 12, wherein the communications include information reflecting states of batteries of the first EV and the second EV, respectively.

14. The method of claim 13, wherein the information includes at least one of battery voltage and state of charge.

15. The method of claim 12, wherein the efficiency criterion comprises that the charging station system is operating at maximum efficiency.

16. The method of claim 12, wherein performing the determination that the efficiency of at least the onboard charger no longer meets the efficiency criterion comprises using an efficiency diagram.

17. The method of claim 12, wherein also a stationary storage is connected to the DC bus using the first connection.

18. The method of claim 12, further comprising changing a voltage of the DC bus in response to the determination.

19. The method of claim 12, further comprising supplying power from a grid to the DC bus.

20. The method of claim 19, wherein the grid has a fee-based power threshold, the method further comprising ensuring that the fee-based power threshold of the grid is not exceeded.

21. The method of claim 12, wherein performing the determination that the efficiency of at least the onboard charger no longer meets the efficiency criterion comprises taking into account an efficiency of a grid-connected converter of the charging station system.
